(19) United States
(12) Patent Application Publication
(10) Pub. No.: US 2008/0189124 A1
(43) Pub. Date: Aug. 7, 2008

(54) Maintenance of public order: provision of capability, training and consultancy services

(76) Inventor: Sam Rosenfeld, Beverly Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/880,711

(22) Filed: Jul. 24, 2007

Related U.S. Application Data
(60) Provisional application No. 60/834,090, filed on Jul. 28, 2006.

(51) Int. Cl. G06Q 99/00

(52) U.S. Cl. 705/1

(57) ABSTRACT

The maintenance of public order is essential. Although law enforcement is adept at dealing with individual or small groups of offenders and larger-scale brawls, there is a lack of ability at dealing with riots and other situations requiring a large scale less-lethal response. The ability to respond with large-scale, less-lethal capability to potential riots is not only a moral imperative, but the negative experiences of Seattle or Los Angeles, when contrasted with the successful resolution of riots in Northern Ireland or France, demonstrate that there is a much better method of resolving riot situations, with far less cost to property and human life.

### CROSS-REFERENCE TO RELATED APPLICATIONS

This patent application claims priority to provisional patent application Ser. No. 60/834,090, entitled MAINTENANCE OF PUBLIC ORDER, PROVISION OF CAPABIITY, TRAINING AND CONSULTANCY SERVICES, filed on Jul. 28,2006.

### STATEMENT RE: FEDERALLY SPONSORED RESEARCH/DEVELOPMENT

Not Applicable

### BACKGROUND

The maintenance of public order is an essential role of law enforcement bodies. Riots, defined by law as an incident involving twelve or more people, are most difficult to manage when the violence is directed either at members of the law enforcement community, property, or another target outside of the group responsible for the violent behavior.

For predominantly cultural reasons the maintenance of public order within the United States of America is achieved by law enforcement officers in small numbers dealing with small numbers of offenders, or in situations involving masses of protestors or offenders, the rapid resort to mounted units and the National Guard.

There is currently an absence of skill in the use of law enforcement or other bodies to engage with and disperse crowds, or when necessary, rioters. This lack of skill is the result of the reliance on brute force coupled with, where appropriate, the use of states of emergency to justify public order activity. In this respect, despite the fact that the capability exists to deal with numbers of people involved in engaging each other, the authorities are ill-equipped to deal with organized and widespread violence, such as in Seattle or Los Angeles, particularly using less-lethal techniques. Current ‘helmet and stick’ approaches do not address the requirements for understanding crowd culture, combatant posture, escalation and the appropriate use of manpower, vehicles and support equipment.

While current methods are sufficient to deal with large-scale, impromptu fights where brute force is effective. However, the current methods are ineffective in dealing with full-scale riotous activity because the response consists of personnel who are ill-equipped and insufficiently trained to deal with large-scale, organized riots.

Globally there is wide experience in dealing with the maintenance of public order. Different legal and moral imperatives have led to different methods of maintaining public order. The delivery of training and consultancy to law enforcement bodies of tactics, techniques and procedures developed specifically for the moral and legal frameworks ensures that they are most effective whilst safeguarding human rights and reducing legal exposure. A bespoke training and consultancy delivers the ability for law enforcement bodies to become better at the maintenance of public order, whilst reducing their exposure.

The creation of private public order units that are available on a contingency or contract basis enables organizations, including law enforcement and disaster response, that did not foresee public order problems or cannot afford a capability, the opportunity to employ such a capability when required.

The creation of a group of qualified, experience public order command professionals that are available on a contingency or contract basis enables organizations, including law enforcement and disaster response, that did not foresee public order problems or cannot afford a capability, the opportunity to employ such a capability when required.

### BRIEF SUMMARY

The present invention creates the ability to use non-lethal techniques on a widespread basis to react to large-scale riot and situations with the potential for riots without the resort to indiscriminate violence. Violence, when employed, is directed, focused, cognizant of the rights of the individual, and employed in such a fashion to defuse, rather than escalate, a situation.

Maintenance of public order acts in a positive manner to keep situations stable and peaceful. If that peace is broken, it acts to resolve the violence quickly and efficiently, but definitely without the emphasis being on brute force.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram depicting the various elements used to maintain public order through the practice of the present invention.

### DETAILED DESCRIPTION

The above description is given by way of example, and not limitation. Given the above disclosure, one skilled in the art could devise variations that are within the scope and spirit of the invention disclosed herein, including various ways of selectively implementing force to maintain public order so as to minimize the use of force and use force only to the degree necessary to maintain order. Further, the various features of the embodiments disclosed herein can be used alone, or in varying combinations with each other and are not intended to be limited to the specific combination described herein. Thus, the scope of the claims is not to be limited by the illustrated embodiments.

The present invention is directed to the maintenance of public order through the provision of capability, training and consultancy services. In this regard, the present invention contemplates maintaining public order via the provision of formed Public Order Units, which incorporate the provision of Public Order Consultancy, and the provision of Public Order Training.

The Public Order Unit, as a capability, is equipped to maintain public order within the legal framework dictated by, or to, contracting authority. To achieve this end, Public Order Units will deploy less-lethal techniques and technology, supported by a lethal capability used only in response to lethal situations. Public Order Unit tactics will deter the escalation of a crowd situation to create a riot. If a riot occurs, the unit's tactics are to take the necessary measures to minimize injury to the innocent, protect property and arrest ring-leaders. As will be understood by those skilled in the art, the delivery of capability may be provided on a pre-paid, contingency funding basis or on a contract basis.

With respect to the provision of Public Order Consultancy, experienced public order operators and commanders will design suitable public order tactics and procedures to meet the legislative requirements of a commissioning authority.

For the provision of Public Order training, experienced public order operators and commanders provide training to law enforcement or other bodies, both private, public and statutory.

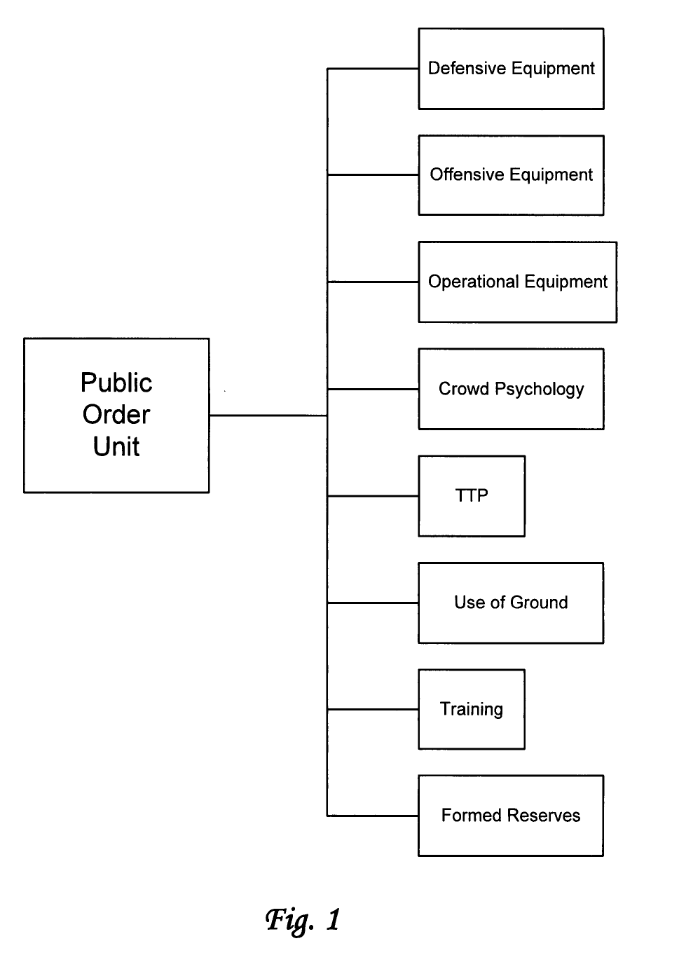

As illustrated in FIG. 1, maintenance of public order is conducted via Public Order Units through the use of a combination of:

Defensive Equipment. Protective equipment for operators involved in Public Order operations. The level of protection is tailored to the situation, but will commonly include:
i. Helmet and visor.
ii. Shoulder, arm and leg protection.
iii. Reinforced boots.
iv. Shield.
v. Fire extinguishers.

Offensive Equipment. Equipment deployed by operators involved in Public Order operations will be tailored to the situation and the individual's task, but may include:
i. Baton.
ii. Individual disabling spray, such as pepper spray.
iii. Appropriate less-lethal weapons, such as bean-bag guns and baton guns.
iv. Lethal capability, to respond to lethal threats.

Operational Equipment. Equipment used at the operational level will depend on the scenario. The equipment in use will develop in line with technology, but may include:
i. Water Cannons.
ii. Vehicles.
iii. JCBs or trucks equipped for removing obstacles.

Crowd Psychology. An understanding of how crowds operate, and the ability to influence that behavior.

Tactics, Techniques and Procedures. TTPs are developed to meet specific instances and scenarios in line with the legal requirements within which Maintenance of Public Order is being conducted. All TTPs emphasize the integration of assets and understanding crowd and riot psychology and mechanics in order to engage causing the most effect with the minimum amount of force.

Use of Ground. The correct use of ground to facilitate movement of Public Order operators and channel crowds or rioters.

Training. Public Order operations do not rely on brute force. Therefore, there is a training requirement to understand the equipment, TTPs, but is a key element of the Maintenance of Public Order, because it is an essential tool for managing the perception by crowds of the intent of the Public Order operators. Posture is the manner in which a Public Order operator is present, the equipment he holds and the stance he takes, ranging from completely out of view to present, in an open, aggressive formation with visors down and shields and batons raised.

Formed Reserves. The ability to respond to the unexpected is essential in maintaining Public Order. The use of formed reserves allows commanders to reinforce areas under threat, or conduct operations into the crowd, as necessary.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A system for maintaining public order comprising:
a. a formed Public Order Unit operative to selectively deploy at least one mechanism selected from the group consisting of defensive equipment, offensive equipment, operational equipment, crowd psychology, tactics, techniques and procedures, use of ground, training, posture and formed reserves.

2. The system of claim 1 wherein said public order unit comprises a public order consultancy component and a public order training component.
